(19) United States
(12) Patent Application Publication
(10) Pub. No.: US 2002/0157550 A1
(43) Pub. Date: Oct. 31, 2002

(54) Cleaning device for printing-press cylinders

(76) Inventor: Torsten Schmutz, Bobingen (DE)

Correspondence Address: Robert C. Faber, Ostrolenk Faber Gerb & Soffen, 1180 Avenue of the Americas, New York, NY, 10036-8403, US

(21) Appl. No.: 09/936,384

(22) PCT Filed: Jan. 5, 2001
(86) PCT No.: PCT/EP01/00062

(30) Foreign Application Priority Data
Jan. 8, 2000 (DE) 10000557.8

(51) Int. Cl. B41F 35/00

(52) U.S. Cl. 101/425

(57) ABSTRACT

A cleaning device for printing machine cylinders and bearings (2, 60) for this for the rotatable mounting of a cloth spindle (4, 92) for a cleaning cloth. At least one of the bearings (2, 60) has a bearing bush (14, 64) which is provided with an external thread (16, 66) and which can therefore be screwed into an internal thread (17, 67) of a side part (20, 70).

The invention relates to a cleaning device for printing machine cylinders according to the preamble of claim 1.

The invention accordingly relates to a cleaning device for printing machine cylinders, containing bearings for the rotatable mounting of a clean-cloth spindle and of a dirty-cloth spindle, in each case at their spindle ends, in side parts, in order to rewind a clean cleaning cloth from the clean-cloth spindle onto the driveable dirty-cloth spindle and, on the path of cloth movement between the two spindles, to bring a cloth portion into contact with a printing machine cylinder to be cleaned.

Known printing machine cylinder cleaning devices of this type normally form a structural unit which is known as a “washing beam”. Such a washing beam is moveable between a basic position, in which it is at a distance from the printing machine cylinder to be cleaned, and a washing position, in which a washing-cloth portion is pressed onto the outer surface of the printing machine cylinder by a pressure element of the washing beam. The washing cloth is in each case then transported further on by the amount of a predetermined cloth portion, so that a new clean washing-cloth portion is opposite the printing machine cylinder when the washing beam is moved back from the washing position into the basic position. The washing cloth is transported further on in this way by means a freewheel drive on the dirty-cloth spindle, said freewheel drive acting in the manner of a ratchet which, during the movement of the washing beam in the direction from the washing position to the basic position, drives the dirty-cloth spindle, but, during the reverse movement from the basic position to the washing position, rotates idly in relation to the dirty-cloth spindle, that is to say without corotating the latter. The washing cloth on the clean-cloth spindle may be dry and be moistened with fluid on its path between the clean-cloth spindle and the pressure element or directly at the pressure element by a moistening device. It is also known to have a moist washing cloth on the clean-cloth spindle. Within the scope of the present invention, the washing cloth is called a “cleaning cloth”, because the invention can also be used for dry cleaning cloths.

So that, particularly when the cloth movement starts, the dry-cloth spindle does not rotate more quickly than the dirty-cloth spindle can receive the cleaning cloth and does not follow on when the dirty-cloth spindle stops, which will result in a loosening and sagging of the cleaning cloth and consequently in the risk of the loose washing cloth being picked up by the printing machine cylinder and carried along, it is known to provide the clean-cloth spindle with a sustained-action brake. This consists, in the prior art, of a brake lining which is prestressed radially against a bearing bolt by a screw via a spring. The disadvantage of this is that even a small rotational movement of the screw may generate too strong or too weak a braking action. A small change in spring excursion results in a pronounced variation in braking force. The braking force therefore cannot be set with sufficient accuracy, and it changes relatively sharply in the event of wear of the brake lining.

The bearings of the clean-cloth spindle and of the dirty-cloth spindle each have a bearing bush which is provided at one end with a flange. The bearing bush and the flange together consist of a one-piece part. To produce this, a relatively large piece of material is necessary, from which a large amount of material has to be removed by cutting in order to form the bush. The flange has, for example, three passage holes for receiving the heads of screws, by means of which the bearing element consisting of the bearing bush and flange can be screwed to a side part of the cleaning device. In this side part are formed locating bores, into which the outer circumference of the bearing bush is fitted. The bearings of the spindles have to be positioned relative to one another with great accuracy, so that the washing cloth runs exactly at right angles to the spindles and over the pressure element, by means of which in each case a cloth portion can be pressed onto the outer surface of the printing machine cylinder to be cleaned. Furthermore, care must be taken to ensure that the press-on pressure of the cloth is equal over the entire cylinder length. The production of the locating bores in the side parts and the production of the bearing elements consisting of the bearing bush and flange are costly.

The invention is intended to achieve the object of designing the bearing arrangements of the spindles in such a way that they can be produced in a shorter time and more cost-effectively, without sufficient accuracy in the positioning of the bearings having to be dispensed with.

This object is achieved, according to the invention, by means of the characterizing features of claim 1.

A cleaning device for printing machine cylinders is characterized, according to the invention, in that at least one of the bearings has a bearing bush which is provided with an external thread and therefore can be screwed into an internal thread of the respective side part, and in that an inner bearing part, which is designed for receiving a spindle end to be carried by it, extends axially at least partially through the bearing bush and is positioned in the bearing bush.

The invention makes it simpler and less expensive to produce and assemble the cleaning device and reduces the production time and assembly time.

Further features of the invention are contained in the subclaims.

The invention is suitable, in particular, for the cleaning with a dry cleaning cloth or for the washing with a moist washing cloth of rubber-blanket cylinders in offset printing machines, but may also be used for the cleaning of other cylinders in offset printing machines and in other types of printing machines.

The invention is described below, by means of a preferred embodiment as an example, with reference to the drawings in which:

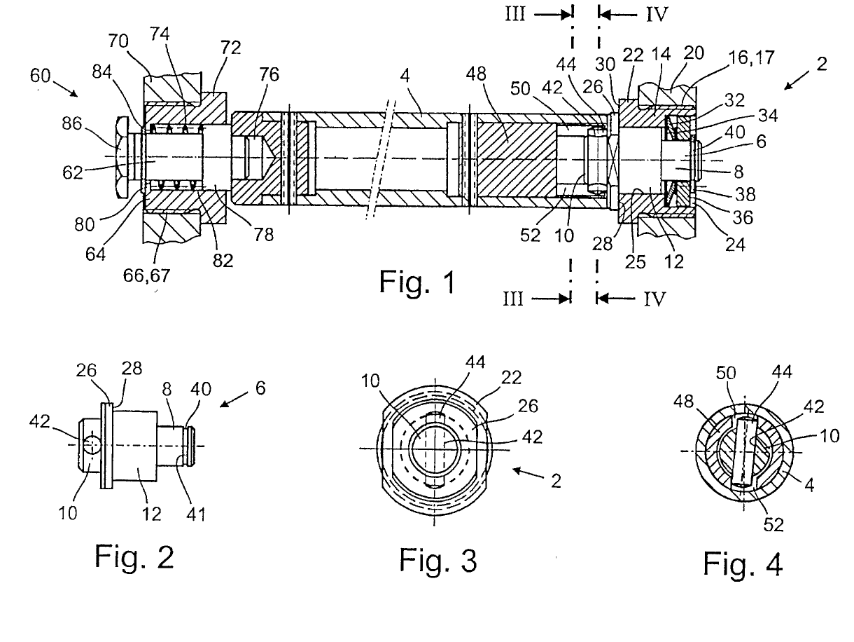

FIG. 1 shows a cutaway axial section through a clean-cloth spindle of a cleaning device according to the invention for printing machine cylinders,

FIG. 2 shows a bearing bolt from FIG. 1, illustrated as being rotated through 90 degrees about its axis of rotation,

FIG. 3 shows a cross section along the plane III-III, as seen in the direction of the arrows of FIG. 1, without the clean-cloth spindle, so that only a bearing and braking unit is shown in an end view,

FIG. 4 shows a cross section along the plane IV-IV, as seen in the direction of the arrows of FIG. 1,

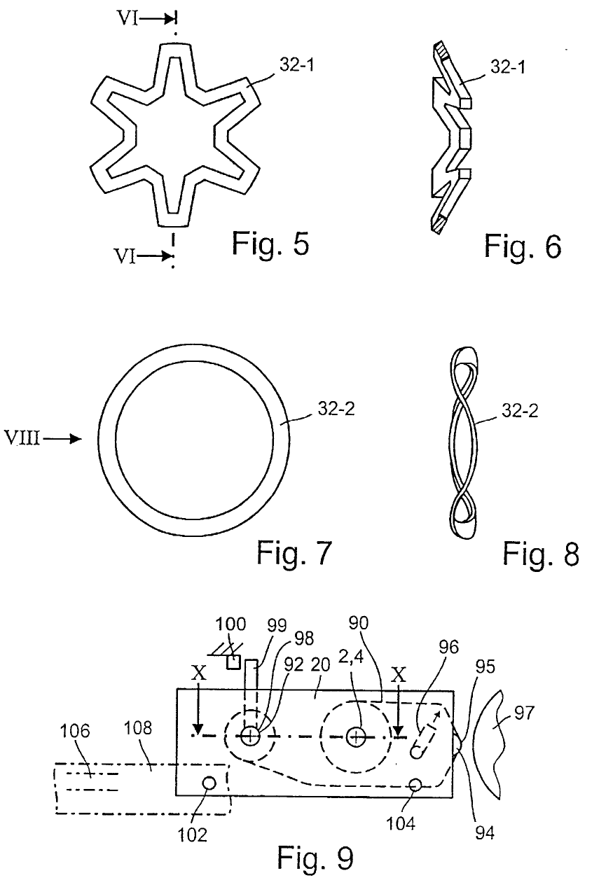

FIG. 5 shows an enlarged end view of a star spring shown in FIG. 1,

FIG. 6 shows an axial section along the plane VI-VI from FIG. 5,

FIG. 7 shows an end view of a shaft spring ring which can be used instead of the star spring of FIGS. 5 and 6,

FIG. 8 shows a side view of the shaft spring ring from FIG. 7, as seen in the direction of the arrow VIII there,

FIG. 9 shows diagrammatically a side view of the cleaning device according to the invention, designed as a washing beam, for washing the outer surface of printing machine cylinders,

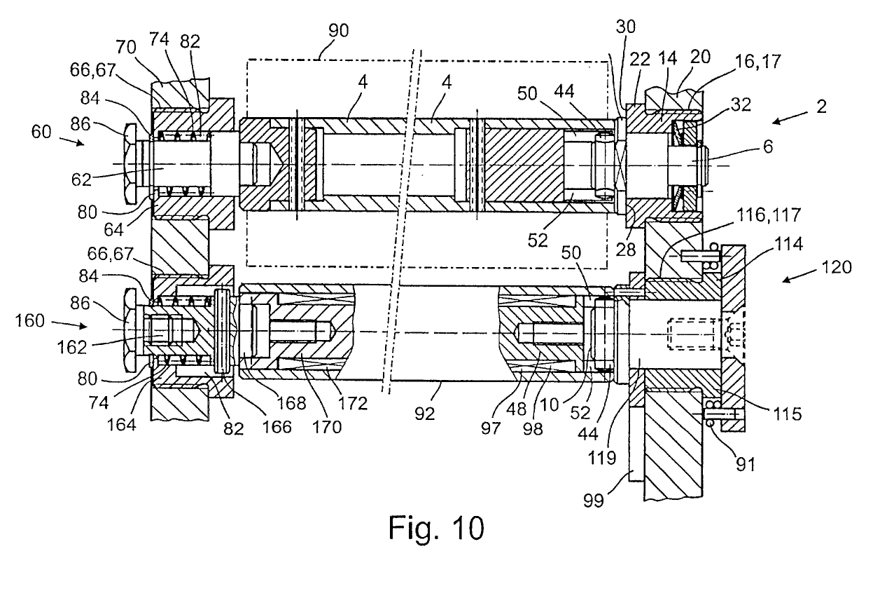

FIG. 10 shows a cutaway longitudinal section along the plane X-X of FIG. 9, which shows the mounting of the clean-cloth spindle and of the dirty-cloth spindle in side parts of the cleaning device.

FIG. 1 shows, at the right-hand end, a bearing and braking unit 2 for the mounting and sustained-action braking of a spindle 4, in particular of a clean-cloth spindle, onto which a cleaning cloth, not illustrated, is wound.

The bearing and braking unit 2 contains a bearing bolt 6 which has an outer end portion 8, an inner end portion 10 and, between the two end portions 8 and 10, a sliding-bearing portion 12 which has a larger diameter than the two end portions 8 and 10 and is mounted rotatably in a bearing bush 14 with which it forms a sliding bearing.

The bearing bush 14 has an external thread 16 with which it is screwed into an internal thread 17 and a side part 20 of the washing beam from the inside of the washing beam. The bearing shell 14 has, at its inner end, an annular collar 22 which projects radially outward beyond the external thread 16 and which bears against the inner face of the side part 20.

The bearing bush 14 has, on its outer face distant from the annular collar 22, a cylindrical depression 24 which has a larger diameter than its sliding-bearing surface 25. The outer end portion 8 of the bearing bolt 6 is located predominantly within the cylindrical depression 24 of the bearing bush 14 and does not project axially beyond this, or only a little.

The bearing bolt 6 has, between its sliding-bearing portion 12 and its inner end portion 10, a radially outwardly projecting annular collar 26 which has a larger diameter than the sliding-bearing portion 12 and which comes to bear, with its end face 28 facing the bearing- bush 14, against an inner end face 30, located opposite the end face 28, of the bearing bush 14. These two end faces 28 and 30 are pressed axially against one another resiliently by a compression spring 32 which is arranged on the outer end portion 8 of the bearing bolt 6 and which is clamped with axial prestress between the bearing bush 14 and the bearing bolt 6. The compression spring 32 is clamped between an outwardly pointing end face 34 facing away from the inner end face 30 and located in the cylindrical depression 24 of the bearing bush 14, against which end face 34 said compression spring comes to bear, and an annular disk 36, against which said compression spring likewise comes to bear. The annular disk 36 is held axially by a supporting element, for example a securing ring 38, inserted into a circumferential groove 40 which is formed at the outer end of the outer end portion 8 of the bearing bolt 6. In this case, the securing ring 38 is supported, in the circumferential groove 40 of the bearing bolt 6, on a groove end face 41 which is directed toward said end face 28 of the bearing-bolt annular collar 26 and which thereby points inward in the same direction as the inner end face 30 of the bearing bush 14.

The compression spring 32 and the annular disk 36, preferably also the securing ring 38, accommodated in the cylindrical depression 24 of the bearing bush 14.

In using only one or a plurality of compression springs 32 and/or none or a plurality of annular disks 36, the spring force of this compression spring and/or the spring excursion can be set. Moreover, at least one adjusting disk can likewise be inserted between the compression spring 32 and the outwardly pointing end face 34 of the bearing bolt 6.

The inner end portion 10 of the bearing bolt 6 has, in its region projecting beyond the bearing-bolt annular collar 26, a diametrical bore 42, into which is inserted a coupling bolt 44 which projects diametrically beyond the inner end portion 10 on both sides.

Arranged in the clean-cloth spindle 4 and connected fixedly in terms of rotation to it is a coupling piece 48 which forms, toward the spindle end, longitudinal grooves 50 and 52 located diametrically opposite one another.

When this spindle end of the clean-cloth spindle 4 is slipped onto the inner end portion 10 of the bearing bolt 6, its coupling bolt 42 engages into the longitudinal grooves 50 and 52 of the coupling piece 48, so that the clean-cloth spindle 4 is connected fixedly in terms of rotation to the bearing bolt 6.

FIG. 2 shows the bearing bolt 6 of FIG. 1, rotated through 90 degrees about its axis of rotation. It makes clear the circumferential groove 40 on the outer end portion 8 of the bearing bolt 6, into which the securing ring 38 in FIG. 1 is inserted and is supported on the groove end face 41 pointing axially toward the end face 28 of the annular collar 26, which end face, in turn, is supported on the inner end face (30) of the bearing shell 14 counter to the force of the compression spring 32, so that these two pressure surfaces 28 and 30 form disk-brake surfaces which prevent the clean-cloth spindle 4 from rotating more quickly than the cleaning cloth is wound from it onto a dirty-cloth spindle. This avoids a loosening and sagging of the cleaning cloth and therefore also the risk of the cleaning cloth being carried along by the printing machine cylinder to be cleaned.

FIGS. 3 and 4 show views along the planes III-III and IV-IV of FIG. 1. The clean-cloth spindle 4 is not shown in FIG. 3.

FIGS. 5 and 6 show, enlarged, what is known as a star spring which can be used as a compression spring 32 according to FIG. 1 and is therefore given the reference numeral 32-1 here.

FIGS. 7 and 8 show what is known as a shaft spring ring 32-2 which can be used, according to FIG. 1, as a compression spring 32.

According to FIG. 1, the clean-cloth spindle 4 is mounted freely rotatably, at its end facing away from the bearing and braking unit 2, on a bearing bolt 62 which, together with a bearing bush 64, forms a further structural unit 60. The bearing bush 64 has an external thread 66 with which it is screwed into an internal thread 67 of a further side part 70 of the cleaning device, said further side part being arranged at an axial distance from the first side part 20. The bearing bush 64 has, at its inner end, an annular collar 72 which has a larger diameter than the external thread 66 of said bearing bush and which comes to bear on an inner face of the side part 70.

The bearing bolt 62 of the bearing unit 60 shown on the left in FIG. 1 can be drawn axially out of a bearing bore 76 of the clean-cloth spindle 4 counter to the force of a compression spring 74. After this bearing bolt 62 has been drawn out of the bearing bore 76, the clean-cloth spindle 4 can be pivoted transversely and then also drawn off from the bearing bolt 6 of the bearing and braking unit 2 at the other spindle end. The insertion of the clean-cloth spindle takes place in reverse order.

The compression spring 74 of the bearing unit 60 is located within the bearing bush 64 and is clamped with prestress, on the one hand, at a radially outward-projecting annular collar 78 of the bearing bolt 62 and, on the other hand, at a radially inward-projecting annular collar 80 of a bearing bore 82 of the bearing bush 64. The annular collar 78 is mounted rotatably in the bearing bore 82.

A securing ring 84 inserted into a circumferential groove 83 of the bearing bolt 62 is supported on the outside of the radially inward-projecting projection or annular collar 80 of the bearing bore 82 and thereby defines the spring prestress and the spring excursion by which the bearing bolt 62 can be moved relative to the bearing bush 64 in the direction of the clean-cloth spindle 4 by the compression spring 74.

The bearing bolt 62 has, at its outer end, a grip 86 for drawing the bearing bolt out of the bearing bore 76 of the clean-cloth spindle 4 counter to the spring force.

FIG. 9 shows diagrammatically a side view of the cleaning device designed as a washing beam. The cleaning cloth 90 is drawn off in steps from the clean-cloth spindle 2 by a dirty-cloth spindle 92 via a pressure element 94 and is wound on. A spray device 96 moistens the cleaning cloth 90 on its path from the clean-cloth spindle 4 to the pressure element 94 or directly at this pressure element 94. The dirty-cloth spindle 92 is provided with a freewheel drive 98 which has in a known way a freewheel bearing 97 in this dirty-cloth spindle 2 and an advancing lever 99. When the washing beam is moved back from a washing position into the basic position shown in FIG. 9, the advancing lever 99 is prevented by a fixed stop 100 from following the movement of the washing beam, so that the advancing lever 99 rotates the dirty-cloth spindle 92 by means of the freewheel bearing 97. During the opposite movement of the washing beam from the basic position shown in FIG. 9 into a washing position, the advancing lever 99 is rotated back automatically by means of a spring 91, without driving the dirty-cloth spindle 92. In the washing position, not shown, the pressure element 94 presses the washing-cloth portion 95 lying on it against the outer surface of a printing machine cylinder 97 to be cleaned. The printing machine cylinder 97 may be, in particular, a rubber-blanket cylinder of an offset printing machine, but also any other type of cylinder in a printing machine.

The washing beam has, on its outer faces, bolts or rollers 102 and 104 engaging into grooves 106 of a holding device 108 which is indicated merely diagrammatically in FIG. 9 by dashed and dotted lines, since such holding devices are known.

FIG. 10 shows, by dashed and dotted lines, the cleaning cloth 90 wound on the clean-cloth spindle 4 and the two bearings 2 and 62 of this clean-cloth spindle 4 according to FIG. 1.

FIG. 10 additionally shows a top view of the dirty-cloth spindle 92. At one end, shown on the right in FIG. 10, it is mounted rotatably by means of a bearing unit 120. This is a sliding bearing and has a bearing bush 114 with an external thread 116, with which it is screwed into a threaded bore 117 of one side part 20 from the outer face of the latter. The bearing bush 114 has a radially outward-projecting annular collar 115 which comes to bear on the outer face of this side part 20. A bearing bolt 119 mounted rotatably in the bearing bush 114 has, on its end portion 10 projecting inward from the bearing bush, a coupling bolt 44 which projects diametrically from said end portion on both sides and which engages into recesses 50 and 52 of a coupling piece 48 which are located diametrically opposite one another. The coupling piece 48 is mounted by means of the freewheel bearing 97 fixedly in terms of rotation with the dirty-cloth spindle 92 only in the direction of rotation of the cloth advance, but freely rotatably in the opposite direction of rotation. The advancing lever 99 is fastened fixedly in terms of rotation to the outer end of the bearing bolt 119.

The left-hand other end of the dirty-cloth spindle 92 is mounted rotatably on the other side part 70 by means of a bearing unit 160. The bearing unit 160 contains a bearing bush 164 with an external thread 66 with which said bearing bush is screwed into an internal thread 67 of the side part 70. A bearing bolt 162 with a grip part 86 can be drawn, counter to the spring force of a compression spring 74 accommodated in the bearing bush 164, out of that end portion of the dirty-cloth spindle 92 which is to be mounted. After said bearing bolt has been drawn out, the dirty-cloth spindle 92 can be pivoted away laterally and then be drawn off from the bearing bolt 10 of the first bearing 120 which is provided with the freewheel drive 98. Parts which are the same as those in FIG. 1 are given the same reference numerals in FIG. 10. The bearing bolt 162 is connected fixedly in terms of rotation to the bearing bush 164 by means of a crosspin 166, but is axially displaceable relative to the bearing bush 164. An inner end portion 168 of the bearing bolt 162 is inserted axially into a coupling piece 170 and is connected fixedly in terms of rotation therein by means of a positive connection (of oval or annular cross section). The coupling piece 170 is arranged in the dirty-cloth spindle 92 and is freely rotatable relative to the latter in the same direction of rotation as the coupling piece 48 of the bearing unit 120 which is provided with the freewheel drive 98. In the opposite direction of rotation, the coupling piece 170 is coupled fixedly in terms of rotation to the dirty-cloth spindle 92 by means of a freewheel bearing 172.

1. A cleaning device for printing machine cylinders, containing bearings (2, 60, 120, 160) for the rotatable mounting of a clean-cloth spindle (4) and of a dirty-cloth spindle (92), in each case at their spindle ends, in side parts (20, 70), in order to rewind a clean cleaning cloth (90) from the clean-cloth spindle (4) onto the driveable dirty-cloth spindle (92) and, on the path of cloth movement between the two spindles, to bring a cloth portion (95) into contact with a printing machine cylinder to be cleaned, characterized in that at least one of the bearings (2, 60, 120, 160) has a bearing bush (14, 64, 114, 164) which is provided with an external thread (16, 66, 116) and which can therefore be screwed into an internal thread (17, 67, 117) of the respective side part (20, 70), and in that an inner bearing part (6, 62, 119, 162), which is designed for receiving a spindle end to be carried by it, extends axially at least partially through the bearing bush and is positioned in the bearing bush.

2. The cleaning device as claimed in claim 1, characterized in that the inner bearing part has a bearing bolt (6, 62, 119, 162) which is mounted rotatably in the bearing bush and which has an end portion, designed as an insertable part, for forming an insertion connection with the spindle end to be carried by it.

3. The cleaning device as claimed in claim 1, characterized in that the inner bearing part has a bearing bolt (6, 119) which is mounted rotatably in the bearing bush (14, 114) and which has an end portion (10), designed as an insertable coupling part, for the rotationally fixed coupling of a spindle end.

4. The cleaning device as claimed in claim 3, characterized in that the bearing bush (14) and the bearing bolt (6) each have at least one end face (28, 30) which are braced resiliently against one another by at least one spring (32) clamped axially with prestress between the bearing bush and the bearing bolt and which thereby generate between themselves a rotational frictional resistance which has to be overcome for the rotation of the bearing bolt relative to the bearing bush.

5. The cleaning device as claimed in claim 2, characterized in that between the bearing bolt (62, 162) and the bearing bush (64, 164) is clamped axially with prestress a spring (74) which urges the bearing bolt inward, in the direction of the spindle end to be carried by the latter, against a stop (80) which is provided on the bearing bush (64, 164), and in that the bearing bolt (62, 162) has a grip part which projects outward from the bearing bush and at which the bearing bolt can be gripped in order to draw it axially outward relative to the bearing bush and at the same time draw it off from the spindle end.

6. The cleaning device as claimed in claim 3, characterized in that, in the case of at least one bearing (120) of the dirty-cloth spindle (4), the bearing bolt (119) is provided, at its end opposite its insertable coupling part (10), with a freewheel drive (98), the rotary drive element of which, during its rotation, corotates the bearing bolt (119) in one direction of rotation, but, during its rotation, not in the opposite direction of rotation.

7. The cleaning device as claimed in claim 6, characterized in that, in the case of the bearing (160) provided at the other end of the dirty-cloth spindle (92), between the bearing bolt (162) and the bearing bush (164) is clamped axially with prestress a spring (74) which urges the bearing bolt (162) inward, in the direction of the spindle end to be carried by the latter, against a stop (80) which is provided on the bearing bush (164), and in that the bearing bolt (162) has a grip part (86) which projects outward from the bearing bush and at which the bearing bolt can be gripped in order to draw it axially outward relative to the bearing bush and at the same time draw it off from the spindle end.

8. The cleaning device as claimed in claim 1, characterized in that, in the case of one bearing (2) of the clean-cloth spindle (4), the inner bearing part has a bearing bolt (6) which is mounted rotatably in the bearing bush (14) and which has an end portion (10), designed as an insertable coupling part, for the rotationally fixed coupling (44) of a spindle end, in that the bearing bush (14) and the bearing bolt (6) each have at least one end face (28, 30) which are braced resiliently against one another by at least one spring (32) clamped axially with prestress between the bearing bush and the bearing bolt and which thereby generate between themselves a rotational frictional resistance which has to be overcome for the rotation of the bearing bolt relative to the bearing bush, in that, in the case of the other bearing (60) of the clean-cloth spindle (4), the inner bearing part has a bearing bolt (62) which is mounted rotatably in the bearing bush (64) and which has an end portion, designed as an insertable part, for forming an insertion connection with the spindle end to be carried by it, in that between the bearing bolt (62) and the bearing bush (64) is clamped axially with prestress a spring (74) which urges the bearing bolt (62) inward, in the direction of the spindle end to be carried by it, against a stop (80) which is provided on the bearing bush (64), and in that the bearing bolt (62) has a grip part (86) which projects outward from the bearing bush (64) and at which the bearing bolt (62) can be gripped in order to draw it axially outward relative to the bearing bush and at the same time draw it off from the spindle end.

9. The cleaning device as claimed in one of the preceding claims, characterized in that it is a structural unit which can be moved back and forth in a holding device (108), relative to the printing machine cylinder (97) to be cleaned, between a basic position, in which said structural unit is at a predetermined distance from the printing machine cylinder, and the cleaning position, in which a cloth portion (95) comes to bear against the printing machine cylinder to be cleaned.

10. The cleaning device as claimed in one of the preceding claims, characterized in that the bearing bush (14, 64, 114, 164) has an annular collar (22, 115) for coming to bear against and therefore for positioning at a side face of the side part (20, 70), the bearing bush being screwed into said side face.

11. A bearing for a cleaning device for printing machine cylinders as claimed in one of the preceding claims, characterized in that it is designed according to one of the preceding claims.
